(19) United States
(12) Patent Application Publication
(10) Pub. No.: US 2014/0024003 A1
(43) Pub. Date: Jan. 23, 2014

(54) TOOTH MODEL USED FOR DENTAL TRAINING AND METHOD OF MANUFACTURING SAME

(71) Applicants: Shigetsugu Iwaki, Kyoto (JP); Kyohei Matsui, Chiba (JP)

(72) Inventors: Shigetsugu Iwaki, Kyoto (JP); Kyohei Matsui, Chiba (JP)

(21) Appl. No.: 13/992,680

(22) PCT Filed: Dec. 9, 2011
(86) PCT No.: PCT/JP2011/078538

§ 371 Date: Oct. 3, 2013

(30) Foreign Application Priority Data
Dec. 9, 2010 (JP) 2010-274967

(51) Int. Cl. G09B 23/28

(52) U.S. Cl. CPC G09B 23/283
USPC 434/263; 264/19

(57) ABSTRACT

Provided are a tooth model having parts corresponding to tartar formed uniformly and a method of manufacturing the tooth model. A tooth model (10) used for dental training comprises a main body having a tooth crown (11) molded to look like the shape of a tooth and a tooth root (12), and protrusions (13) seamlessly formed on the surface of the main body, and the main body and the protrusions (13) are composed of the same material. The protrusions (13) and the main body of the tooth model (10) can be integrally molded. Therefore, the repeated use of the common molding die allows the parts corresponding to tartar to be formed uniformly.

### TECHNICAL FIELD

The present invention relates to a tooth model for use in dental trainings, and to a method of producing the model.

### BACKGROUND ART

Tooth models are mainly used for dental trainings of dental treatment, and tooth models suitable to various kinds of dental trainings are increasingly in demand as tooth models are becoming popular in the world. A type of dental trainings includes a dental training for removing tartar from teeth.

Conventionally, some tooth models used for training for removing tartar are produced by attaching a material equivalent to tartar to a surface of a tooth model, (Patent Documents 1 and 2 are referred to). A user is allowed to carry out training for removing tartar from a surface of a tooth model by scraping off attachment using a scaler and the like.
[Patent Document 1] Japanese Unexamined Patent Application, Publication No. 2005-234250
[Patent Document 2] Japanese Unexamined Patent Application, Publication No. 2007-41083

### DISCLOSURE OF THE INVENTION

### Problems to be Solved by the Invention

However, since a material equivalent to tartar is manually attached to the conventional tooth model, it is very difficult to prevent variation in how the material is attached (particularly, a place to be attached and the attaching force) among a plurality of tooth models. Consequently, it has not been possible to keep a skill obtained through the training consistent or evenly evaluate the result of the training of the user.

In consideration of the situation described above, the object of the present invention is to provide a tooth model that allows forming of a part equivalent to tartar uniformly, and to provide a method of producing the tooth model.

### Means for Solving the Problems

The inventor, and the concerned personnel, of present invention present the following invention for solving the aforementioned problems.

(1) A tooth model used for a dental training, the tooth model including:

a main body that is formed in imitation of a form of a tooth and includes a tooth crown and a tooth root; and

a protrusion protruding from a surface of the main body seamlessly, wherein

the main body and the protrusion are made of the same material.

(2) The tooth model noted in (1), in which the protrusion has a size of 0.3 mm to 0.7 mm, both ends inclusive, in a plan view.

(3) The tooth model noted in (1) or (2), in which the protrusion has an edge portion on a tooth root-side of the protrusion having a form expanded toward the tooth root side in a plan view.

(4) The tooth model noted in (3), in which the protrusion has an edge portion on the tooth root-side having a partial form of a circular arc or elliptical circular arc in a plan view.

(5) The tooth model noted in any of (1) through (4), in which the protrusion has a maximum height of 0.15 mm to 0.35 mm, both ends inclusive.

(6) The tooth model noted in any of (1) through (5), in which the protrusion has a form having no sharp-angle corner in a cross-sectional view that is perpendicular to a tooth axis of the tooth model.

(7) The tooth model noted in (6), in which the protrusion has a partial form of a circular arc or elliptical circular arc in a cross-sectional view that is perpendicular to the tooth axis.

(8) The tooth model noted in any of (1) through (7), in which the material provides a Brinell hardness of 20 to 30, both ends inclusive, and provides a flexural strength of 700 kgf/cm² to 1000 kgf/cm², both ends inclusive.

(9) The tooth model noted in any of (1) through (8), in which the dental training is that for removing tartar.

(10) A method of producing a tooth model used for a dental training, the method

that uses an elastically deformable molding die having a concave part formed substantially symmetrical to a form of the tooth model, with the concave part provided with a small dent on a surface of the concave part and includes the steps of:

supplying the concave part with a material fluid that is a raw material for the tooth model;

causing the material fluid to solidify in the concave part to form the tooth model having a protrusion in a form substantially symmetrical to the miniature dent on a surface of the tooth model; and

extracting the tooth model from the concave part.

### Effects of the Invention

The present invention is configured so that the protrusion corresponding to tartar is made of the same material as the main body seamlessly between the protrusion and the main body, and thereby an integral molding with the main body is enabled. Therefore, it is possible to repeatedly use a common molding die, enabling uniform forming of the part corresponding to tartar.

### BRIEF DESCRIPTION OF THE DRAWINGS

FIG. 1 is an oblique view diagram showing a usage mode of a tooth model according to an embodiment of the present invention;

FIG. 2 is a cross-sectional diagram of FIG. 1 along the line II-II;

FIG. 3 is a diagram showing an enlargement of the a portion shown in FIG. 2;

FIG. 4 is a plan view diagram of a protrusion shown in FIG. 2 and the vicinity of the protrusion;

FIG. 5 is a cross-sectional diagram of FIG. 4 along the line V-V; and

FIGS. 6(A)-(C) are diagrams showing the process of producing the tooth model according to the aforementioned embodiment.

### EXPLANATION OF REFERENCE NUMERALS

1: jaw model
10: tooth model
11: tooth crown
12: tooth root
121: tooth root-side surface
123: tooth crown-side surface
13: protrusion
131: apex portion
133, 135: end portion
134, 136: edge portion
20: tooth pedestal
21: insertion hole
30: model gum
50: molding die
53: cavity part
531: miniature dent

### PREFERRED MODE FOR CARRYING OUT THE INVENTION

The following is a description of an embodiment of the present invention with reference to the accompanying drawings,

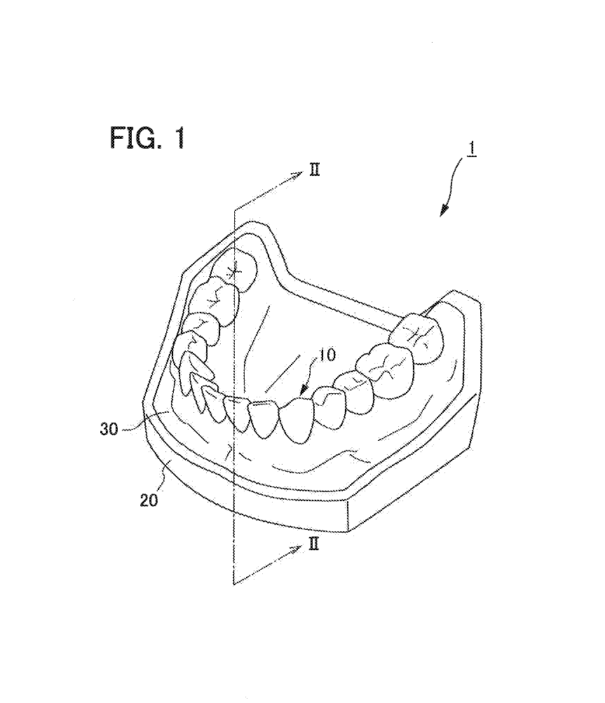

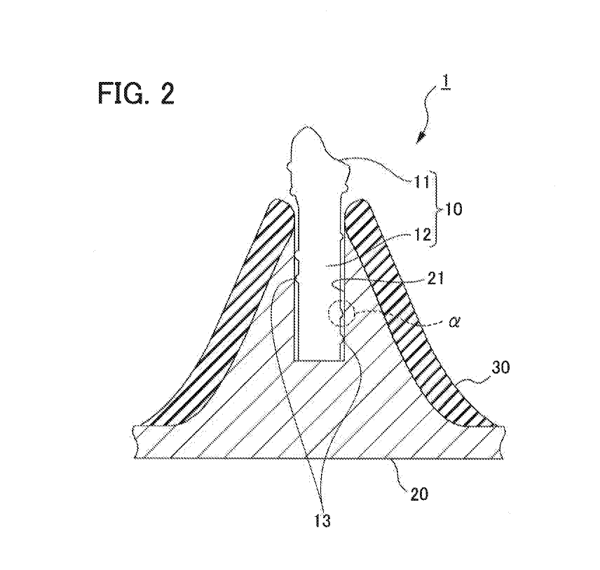

FIG. 1 is an oblique view diagram of a jaw model 1 that includes a tooth model 10 according to an embodiment of the present invention; and FIG. 2 is a cross-sectional diagram of FIG. 1 along the line II-II.

The jaw model includes the tooth model 10, a tooth pedestal 20, and a model gum 30. The tooth model 10 is used for a dental training and includes a tooth crown 11 and a tooth root 12. The tooth root 12 is inserted into an insertion hole 21 arranged along a tooth column of the tooth pedestal 20, and such tooth pedestal 20 is covered with the model gum 30 so that the tooth model 10 is supported by the tooth pedestal 20.

The tooth crown 11 and the tooth root 12 are formed in imitation of the form of a tooth, and they constitute a main body of the tooth model 10. The tooth model 10 according to the present invention includes a protrusion 13 that protrudes from a surface of the main body seamlessly. Such protrusion 13 can be formed integrally with the main body, and therefore a part corresponding to tartar can be formed uniformly by repeatedly using a common molding die (described in detail later). It is appreciated that so long as a tooth model is provided with the protrusion 13, such a tooth model in which another member is further attached onto the protrusion 13 (N.B.: there will be a seam intervening between the other member and the main body) will be included in the spirit and scope of the present invention.

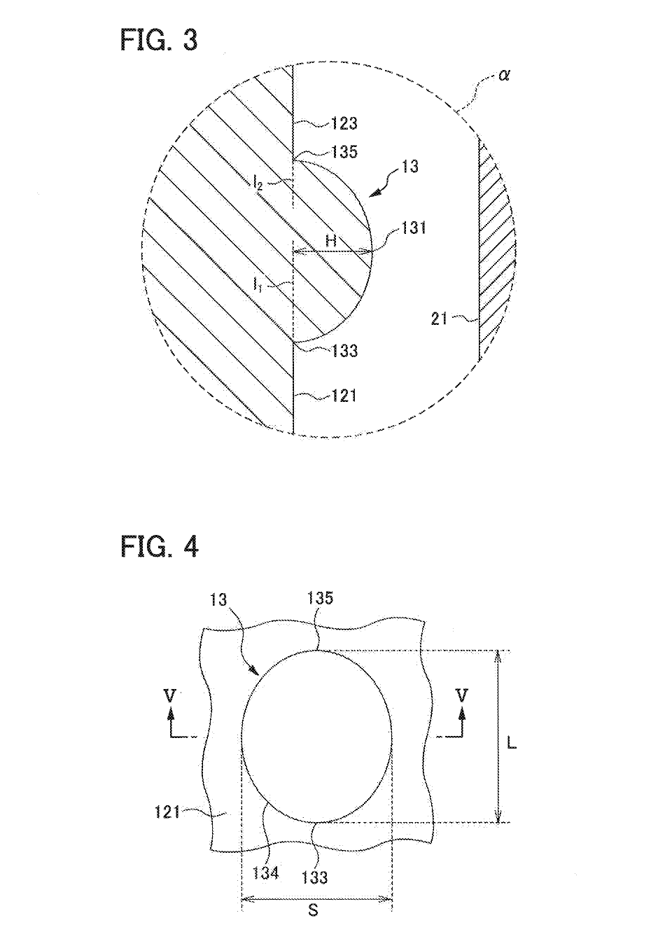

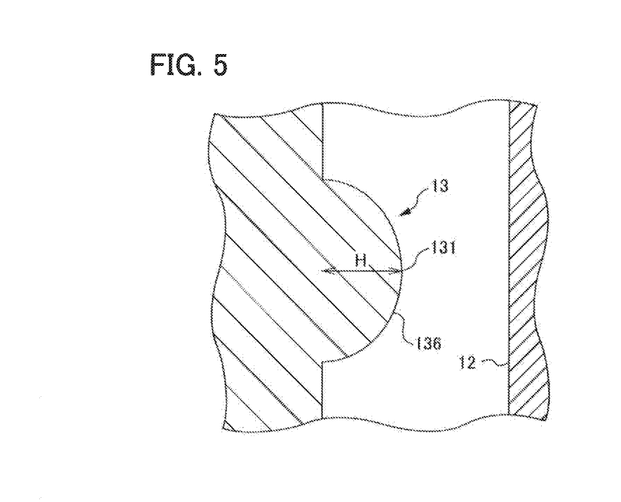

FIG. 3 is a diagram showing an enlargement of the a portion shown in FIG. 2. FIG. 4 is a plan view diagram of a protrusion shown in FIG. 2 and the vicinity of the protrusion. FIG. 5 is a cross-sectional diagram of FIG. 4 along the line V-V.

The protrusion 13 of the present embodiment is disposed in both the tooth crown 11 and the tooth root 12 but it is not limited thereto. An alternative configuration may be such that the protrusion 13 is disposed in only the tooth crown 11 or tooth root 12. The number of the protrusion 13 is not limited. Rather, the number may be singular or plural. Further, the form and the size of the protrusion 13 are not particularly limited. Rather, the protrusion may be a sphere, cuboid, cube, or indefinite shape, of any given size. In a case where a plurality of the protrusions 13 is formed, the form and the size of the protrusions 13 are preferred to be mutually and substantially the same. Alternatively, the form and size may be mutually different.

However, the protrusion 13 desirably has a size of 0.3 mm or larger, more desirably 0.35 mm or larger, or most preferably 0.4 mm or larger, in a plan view. With such a configuration, when the protrusion 13 is removed with a removal instrument (e.g., various kinds of scalers) in dental training, an appropriate level of force as in actually tartar removal is required, and the user is provided with a similar feeling as in actual tartar removal, and therefore it is possible to further improve a result of the dental training. Further, the protrusion 13 desirably has a size of 0.7 mm or smaller, more desirably 0.65 mm or smaller, or most preferably 0.6 mm or smaller, in a plan in contact with the protrusion 13 in a dental training, a feeling conveyed to a person holding the removal instrument is closer to the case of actually contacting tartar, and therefore it is possible to further improve a result of the dental training.

It is noted that the plan view is defined as a visual field when the protrusion is viewed from a direction orthogonal to a surface of the main body located near the protrusion. The size is defined as a size in relation to all directions going through the center of gravity of the protrusion in a plan view. For example, the size of 0.3 ram to 0.7 mm both ends inclusive, means that the minimum value (for example, a shorter diameter S in a case where a plan view of the protrusion 13 is an ellipse) of the size in relation to all directions is 0.3 mm or larger, and that the maximum value (for example, a larger diameter L in the case where the plan view of the protrusion 13 is the ellipse) is 0.7 mm or smaller. Further, in a case where there is a plurality of protrusions, the size means the average value of the sizes of all of them.

Incidentally, the majority of tartar removal instruments generally has a tip of a partiaz circular arc and is moved from a tooth root side to a tooth crown side to remove tartar. Accordingly, the protrusion 13 is preferably configured so that an edge portion 134 on the tooth root side (i.e., the lower side in FIGS. 2 and 4) has a form expanded toward the tooth root side in a plan view. With this configuration, when a dental training is carried out, the tartar removal instrument contacts the protrusion 13 on a face or a plurality of points of the instrument, giving the user a feeling similar to a feeling that the user obtains in removing actual tartar. Further, with the configuration, applied force from the tartar removal instrument is evenly exerted to the entirety of the protrusion 13, and therefore, removal of the protrusion 13 requires an appropriate magnitude of force similar to removing actual tartar.

The form expanded toward the tooth root side is not particularly limited, and it may rather be configured by a straight line and/or a curve. While a partial form of a circular arc or elliptical circular arc is preferable from the standpoint of easily obtaining the above described effect, such a configuration is not particularly limited, and rather the sectional form may be formed by a polygon (i.e., triangle or higher polygonal), a curve, or a combination thereof.

Now returning to FIG. 3, the protrusion 13 desirably has a maximum height H of 0.15 mm or larger, more desirably 0.175 mm or larger, or most desirably 0.20 mm or larger. This configuration makes it possible to prevent the user from letting a tartar removal instrument from going over the protrusion 13 without sensing it, thereby proving the user with a feeling similar to a feeling which the user obtains when removing actual tartar. Further, the protrusion 13 desirably has a maximum height of 0.35 mm or smaller, more desirably 0.325 mm or smaller, or most desirably 0.30 mm or smaller. This configuration makes it possible to prevent the protrusion 13 from getting caught in a miniature dent 531 (described later) of a molding die when the tooth model 10 is extracted from the molding die, thereby facilitating the extract of the tooth model 10. In a case where there is a plurality of protrusions, the maximum height is represented by the average value of the maximum heights of all of the protrusions.

The maximum height H of the protrusion 13 is defined as the maximum value (i.e., the distance between an apex portion 131 and a virtual plane I₁ as shown in FIG. 3) of a height from a plane (i.e., the virtual plane I₁ shown in FIG. 3) produced by extending a tooth root-side surface 121 that is located on the tooth root side, of the surface of the main body in the surrounding of the protrusion 13. That is, the maximum height H of the protrusion 13 means a height required for the tartar removal instrument to climb over the protrusion 13 after moving it from the tooth root side to the tooth crown side to come in contact with the end portion 133 of the protrusion 13 on the tooth root side. In many cases, while the maximum height H is the same or approximately the same as the maximum value of a height from a plane (i.e., a virtual plane I₂ shown in FIG. 3) produced by extending a tooth crown-side surface 123 located on the tooth crown side, of the surface of the main body in the surrounding of the protrusion 13, there may be a possibility of the aforementioned two heights being different from each other in a case where a surface of the main body in the surrounding of the protrusion 13 is greatly curved or distorted.

As shown in FIG. 5, the protrusion 13 preferably has an edge portion 136 formed to have no sharp-angle corner in a cross-sectional view orthogonal to the tooth axis, or more preferably to have a partial form of a circular arc or elliptical circular arc. Such a configuration prevents the protrusion 13 from getting caught in the miniature dent 531 (described later) of the molding die when the tooth model 10 is extracted therefrom, thereby facilitating the extraction of the tooth model 10. The partial form, however, may be constituted by a straight line, any given curve, or a combination thereof. It is appreciated that the sharp-angle corner means a corner of an angle of 90 degrees or smaller.

A material constituting the protrusion 13 and the main body may be any given material provided that it is usable as a material for a tooth model. An exemplary material is an epoxy resin. However, from the standpoint of obtaining a higher training effect with the protrusion 13 having a form and size as described above, a preferable material has a Brinell hardness of 20 to 30, both ends inclusive, and a flexural strength of 700 kgf/cm² to 1000 kgf/cm², both ends inclusive. It is noted that the Brinell hardness is measured in compliance with Japanese Industrial Standard (JIS) Z 2243 and that the flexural strength is measured in compliance with JIS K6911. Such a material will be appropriately selected from among the aforementioned typical materials.

The tooth model 10 described above is used suitably for training of removing tartar. That is, in the state of the tooth model 10 being supported by the tooth pedestal 20, a tartar removal instrument is operated to scrape the protrusion 13 off the tooth model 10 in a method similar to actual removal of tartar. The tooth model 10 according to the present invention allows an integrated forming, making it possible to form the protrusion 13 uniformly by repeatedly using a common molding die. This makes it possible to keep a skill that is obtained through the training consistent, and uniformly evaluate a result of training for the users. It is noted that the tooth model 10 may be used for purposes other than training for tartar removal.

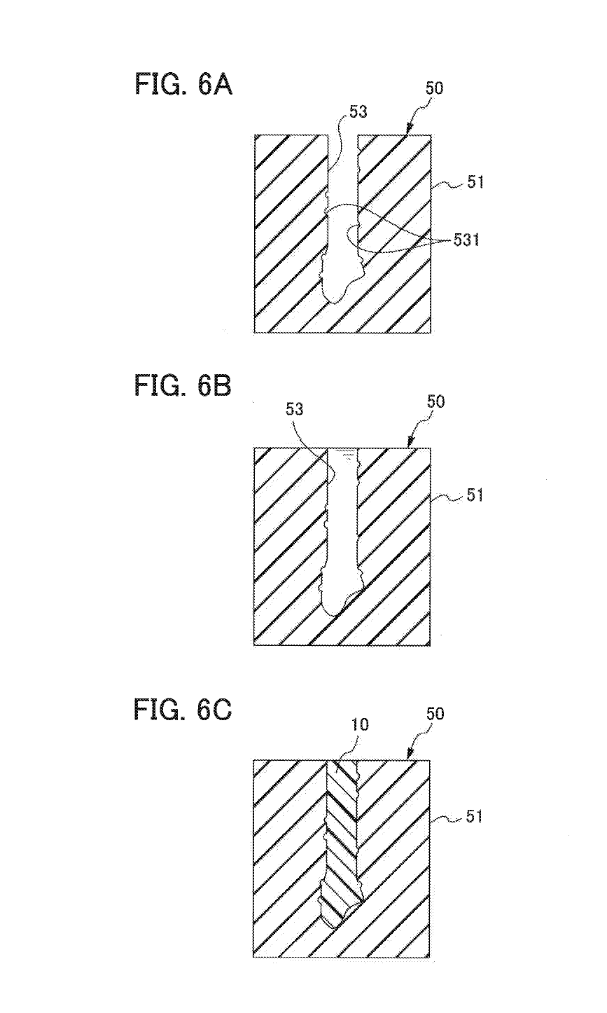

FIGS. 6(A)-(C) are diagrams showing the process of producing the tooth model 10, Next a description of a method of producing the tooth model with reference to FIGS. 6(A)-(C).

The method according to the present invention uses an elastically deformable molding die 50 that includes a cavity part 53 having a form substantially symmetric to the form of the tooth model 10 and in which a miniature dent 531 is disposed in a surface of the cavity part 53 (FIG. 6 (A)). A material for the molding die 50 may be an elastic material which is not affected by the material of the tooth model 10 and, for example, a silicone resin. It is noted that the molding die 50 may be produced by a typical method.

The cavity part 53 of the aforementioned molding die 50 is supplied with a material fluid that is a raw material for the tooth model 10 (FIG. 6 (B)), and the material fluid is solidified in the cavity part 53 by cooling and the like. This process forms the tooth model 10 having on its surface the protrusion 13 of a form substantially symmetrical to the miniature dent 531 (FIG. 6 (C)).

Then, the tooth model 10 is extracted from the cavity part 53. The method of extraction is not limited. For example, the molding die 50 may be divided on a plane passing through the center of the cavity part 53. In this event, although the protrusion 13 may possibly get caught in the cavity part 53 (in many cases, it is related to a circumferential direction of the tooth model 10), the protrusion 13 can get out of the cavity part 53 as a result of the molding die 50 being elastically deformed. If the maximum height of the protrusion 13 (or the maximum depth of the miniature dent 531) is within the above described range, or if the protrusion 13 (or the miniature dent 531) has a form of having no corner in a cross-sectional view orthogonal to the tooth axis of the tooth model 10, the protrusion 13 can more easily get out of the cavity part 53.

Such molding die 50 is repeatedly used to enable mass production of the tooth models on each of which the protrusion 13 is formed uniformly.

The present invention is in no way limited by the embodiment described above. Any modification, improvement, and the like, within the scope of realizing the object of the present invention are included therein.

### EXAMPLES

Tooth models (with Brinell hardness of 25, and flexural strength of 899 kgf/cm²) were produced by: using three kinds of molding dies having 24 pieces of semi-circular miniature dents of respective diameters of 0.3 mm, 0.5 mm or 0.7 mm; and using an epoxy resin as raw material. Seven panelists each using an ultrasonic scaler, a sickle scaler and a curette scaler, respectively, for the three kinds of produced tooth models were subjected to dental trainings for removing tartar. After the dental training, each panelist evaluated for items shown in Table 1. Evaluation points are as follows:

5: Agree

4: Agree to an extent

3: Cannot be determined

2: Disagree to an extent

1: Disagree

TABLE 1

| Evaluation | Ultrasonic scaler | | | Sickle scaler | | | Curette scaler | | |
|---|---|---|---|---|---|---|---|---|---|
| item | 0.3 mm | 0.5 mm | 0.7 mm | 0.3 mm | 0.5 mm | 0.7 mm | 0.3 mm | 0.5 mm | 0.7 mm |
| A | 3.7 ± 1.1 | 4.6 ± 0.8 | 4.8 ± 0.4 | 3.7 ± 1.3 | 5.0 ± 0.0 | 5.0 ± 0.0 | 3.9 ± 1.1 | 5.0 ± 0.0 | 5.0 ± 0.0 |
| B | 3.6 ± 1.1 | 4.7 ± 0.5 | 3.3 ± 0.8 | 3.7 ± 1.0 | 4.6 ± 1.1 | 3.3 ± 0.8 | 3.7 ± 1.0 | 4.4 ± 1.1 | 3.3 ± 0.8 |
| C | 2.3 ± 1.1 | 4.1 ± 0.9 | 3.8 ± 1.2 | 3.0 ± 1.0 | 4.6 ± 1.1 | 3.2 ± 1.5 | 3.0 ± 1.0 | 4.6 ± 1.1 | 3.2 ± 1.5 |
| D | 2.7 ± 1.1 | 4.4 ± 0.8 | 4.5 ± 0.5 | 2.6 ± 0.8 | 4.4 ± 1.1 | 3.3 ± 1.6 | 2.6 ± 0.8 | 4.3 ± 1.1 | 3.3 ± 1.6 |
| E | 2.9 ± 0.7 | 3.9 ± 1.1 | 3.2 ± 0.8 | 3.4 ± 0.5 | 4.1 ± 1.1 | 3.7 ± 0.8 | 3.3 ± 0.5 | 4.3 ± 1.0 | 3.7 ± 0.8 |
| F | 3.7 ± 1.0 | 4.3 ± 1.0 | 4.0 ± 0.9 | 3.9 ± 0.7 | 4.9 ± 0.4 | 4.0 ± 1.3 | 3.9 ± 0.7 | 4.9 ± 0.4 | 4.0 ± 1.3 |

Item A: Easy to sense protrusion
Item B: Feeling when sensing the protrusion resembles tartar
Item C: Force required to scrape off the protrusion is appropriate
Item D: Easy to discern a feeling of removing the protrusion
Item E: Feeling when the protrusion is removed is closer to tartar than in removing resin attachment
Item F: Feeling when the protrusion is removed is closer to tartar than in removing a manicure attachment article

1. A tooth model used for a dental training, the tooth model comprising:
a main body that is formed in imitation of a form of a tooth and comprises a tooth crown and a tooth root; and
a protrusion protruding from a surface of the main body seamlessly, wherein
the main body and the protrusion are made of the same material.

2. The tooth model according to claim 1, wherein the protrusion has a size of 0.3 mm to 0.7 mm, both ends inclusive, in a plan view.

3. The tooth model according to claim 1, wherein the protrusion comprises an edge portion on a tooth root side of the protrusion having a form expanded toward the tooth root side in a plan view.

4. The tooth model according to claim 3, wherein the protrusion comprises an edge portion on the tooth root side having a partial form of a circular arc or elliptical circular arc in a plan view.

5. The tooth model according to claim 1, wherein the protrusion has a maximum height of 0.15 mm to 0.35 mm, both ends inclusive.

6. The tooth model according to claim 1, wherein the protrusion has a form having no sharp-angle corner in a cross-sectional view that is perpendicular to a tooth axis of the tooth model.

7. The tooth model according to claim 6, wherein the protrusion comprises a partial form of a circular arc or elliptical circular arc in a cross-sectional view that is perpendicular to the tooth axis.

8. The tooth model according to claim 1, wherein the material provides a Brinell hardness of 20 to 30, both ends inclusive, and provides a flexural strength of 700 kgf/cm² to 1000 kgf/cm², both ends inclusive.

9. The tooth model according to claim 1, wherein the dental training is that for removing tartar.

10. A method of producing a tooth model used for a dental training,
the method that uses an elastically deformable molding die comprising a concave part formed substantially symmetrically to a form of the tooth model, with the concave part provided with a miniature dent on a surface of the concave part and comprises the steps of:
supplying the concave part with a material fluid that is a raw material for the tooth model;
causing the material fluid to solidify in the concave part to form the tooth model having a protrusion of a form substantially symmetrical to the miniature dent on a surface of the tooth model; and
extracting the tooth model from the concave part.
